(19) United States
(12) Patent Application Publication
(10) Pub. No.: US 2015/0078141 A1
(43) Pub. Date: Mar. 19, 2015

(54) METHOD AND SYSTEM FOR A HIJRI CALENDAR

(71) Applicant: DESIRE2LEARN INCORPORATED, Kitchener (CA)

(72) Inventor: Ali GHASSEMI, Kitchener (CA)

(73) Assignee: DESIRE2LEARN INCORPORATED, Kitchener (CA)

(21) Appl. No.: 14/030,344

(22) Filed: Sep. 18, 2013

(51) Int. Cl. G04G 9/08

(52) U.S. Cl. CPC G04G 9/085
USPC 368/28

(57) ABSTRACT

A method and system for a Hijri calendar are provided. The method includes: receiving date input for a date conversion; determining a conversion type associated with the date input; determining whether the date input falls within a predetermined Hijri calendar date range; and if the date input falls within the range, using the predetermined Hijri calendar to convert the date input, otherwise, using a predetermined Hijri conversion algorithm to convert the date input and returning a converted date output. The system includes: a calendar module configured to receive date input for a date conversion and determine a conversion type associated with the date input; and a conversion module configured to determine whether the date input falls within a predetermined Hijri calendar date range and further configured to, if the date input falls within the range, use the predetermined Hijri calendar to convert the date input, otherwise, use a predetermined Hijri conversion algorithm to convert the date input and return a converted date output.

### FIELD

The present disclosure relates generally to converting between or among calendars. More particularly, the present disclosure relates to a method and system for a Hijri calendar.

### BACKGROUND

There are many calendars used around the world in different countries or cultures. As one example, the Islamic calendar or Hijri calendar is a lunar calendar consisting of 12 months of 29 or 30 days. The Hijri calendar is used to date religious holidays by Muslims. Traditionally, each month begins with a first visual sighting of a lunar crescent by a religious leader or authority. Due to this visual sighting requirement, the length of a month may not be determined until the beginning of the next month.

The Hijri calendar has been observed by Muslims and Muslim countries for many centuries. Although many countries rely on the Hijri calendar to date religious events, because the predicted date when a lunar crescent is visible and the date the religious leader observes the lunar crescent do not always align, there can be difference in the length of each month. As such, there has been less adoption of the calendar for civil purposes. With the dating of the Hijri calendar being variable, there can be conversion issues when comparing the Hijri calendar to the Gregorian or other calendars.

Saudi Arabia, which does use the Hijri calendar to date civil events, has developed a fixed calendar based on the Hijri calendar dates but uses further astronomical calculations to determine the changing months of the Hijri calendar. This calendar is referred to as the Umm al-Qura.

As the Umm al-Qura and the concept of having a fixed Hijri calendar gains further acceptance in Muslim communities, it is desirable to provide an improved method and system for a civil Hijri calendar.

The above information is presented as background information only to assist with an understanding of the present disclosure. No determination has been made, and no assertion is made, as to whether any of the above might be applicable as prior art with regard to the present disclosure.

### SUMMARY

In a first aspect, the present disclosure provides a method for managing a Hijri calendar including: receiving date input from a first predetermined calendar for a date conversion; determining a conversion type associated with the date input; determining whether the date input falls within a predetermined Hijri calendar date range; if the date input falls within the range, using the predetermined Hijri calendar to convert the date input, otherwise, using a predetermined Hijri conversion algorithm to convert the date input; and returning a converted date output.

In a particular case, the receiving of the date input may include receiving an originating date and a date adjustment component.

In another particular case, the determining as to whether the date input falls within a predetermined Hijri calendar date range may include: determine at least one resulting date by applying the date adjustment component to the originating date; determining whether the at least one resulting date falls within the date range of the predetermined Hijri calendar; and if the at least on resulting date falls within the date range, using the predetermined Hijri calendar to convert the date input, otherwise, using the predetermined Hijri conversion algorithm to convert the at least one resulting date.

In yet another particular case, if the date is converted using the predetermined Hijri conversion algorithm, the converted date output may be a date range of possible conversion dates.

In still another particular case, if the date is converted using the predetermined Hijri conversion algorithm, the converted date output may be a date and a warning that the date may be inaccurate.

In a particular case, the first predetermined Hijri calendar used to convert the date input may be based upon a user's location.

In another particular case, the predetermined Hijri calendar used to convert the date input may be selected by a user.

In yet another particular case, the method may further include: determining if the date range of the predetermined Hijri calendar has been updated; and if the date range has been updated, updating the conversion of any converted dates falling within the updated date range of the predetermined Hijri calendar.

In still yet another particular case, if the date input falls outside of the predetermined Hijri calendar, querying at least one third party system or database to retrieve a more accurate converted date for the date input.

In yet another particular case, the method may further include: receiving a change in the user's location to a new location; determining whether a different predetermined Hijri calendar is used at the new location; and, if a different predetermined Hijri calendar is used at the new location, updating any converted dates using the different predetermined Hijri calendar used in the new location.

In further aspect, the present disclosure provides a system for a Hijri calendar including: a calendar module configured to receive date input from a first predetermined calendar for a date conversion and to determine a conversion type associated with the date input; and a conversion module configured to determine whether the date input falls within a predetermined Hijri calendar date range and further configured to, if the date input falls within the range, use the predetermined Hijri calendar to convert the date input, otherwise, use a predetermined Hijri conversion algorithm to convert the date input and return a converted date output.

In a particular case, the calendar module may be further configured to receive an originating date and a date adjustment component.

In another particular case, the conversion module, when determining whether the date input falls within a predetermined Hijri calendar date range, may be further configured to: determine at least one resulting date by applying the date adjustment component to the originating date; determining whether the at least one resulting date falls within the date range of the predetermined calendar; and if the at least one resulting date falls within the date range, sung the predetermined Hijri calendar to convert the at least one resulting date, otherwise, using the predetermined Hijri conversion algorithm to convert the at least one resulting date.

In yet another particular case, if the date is converted using the predetermined Hijri conversion algorithm, the calendar module may be configured to return the converted date output as a date range of possible conversion dates.

In still yet another particular case, if the date is converted using the predetermined Hijri conversion algorithm, the calendar module may be configured to return the converted date output as a date and a warning that the date may be inaccurate.

In a particular case, the predetermined Hijri calendar used to convert the date input may be based upon a user's location.

In another particular case, the conversion module may be further configured to: determine if the date range of the predetermined Hijri calendar has been updated; and, if the date range has been updated, the conversion module may be further configured to update the conversion of any converted dates falling within the updated date range of the predetermined Hijri calendar.

In yet another particular case, the system may include a connection module configured to query at least one third party system or database to retrieve a more accurate converted date for the date input, the date input falls outside of the predetermined Hijri calendar.

In still yet another particular case, the conversion module may be further configured to: receive a change in the user's location to a new location; determine whether a different predetermined Hijri calendar is used at the new location; and, if a different predetermined Hijri calendar is used at the new location, update any converted dates using the different predetermined Hijri calendar used in the new location.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 illustrates a system for a Hijri calendar according to an embodiment;

FIG. 2 is a flowchart illustrating a method for a Hijri calendar according to an embodiment; and

FIG. 3 is a flowchart illustrating a method for date adjustment using a system for a Hijri calendar according to an embodiment.

### DETAILED DESCRIPTION

The following description with reference to the accompanying drawings is provided to assist in a comprehensive understanding of example embodiments as defined by the claims and their equivalents. The following description includes various specific details to assist in that understanding but these are to be regarded as merely examples. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding. Accordingly, it should be apparent to those skilled in the art that the following description of embodiments is provided for illustration purpose only and not for the purpose of limiting the invention as defined by the appended claims and their equivalents.

Generally, the present disclosure provides embodiments of a method and system for a Hijri calendar. The system receives a date from a user or an application. The system determines whether the date falls within the date range established by a predetermined Hijri calendar, for example, the Umm al-Qura or other fixed Islamic or Hijri calendar. If the date is within the date range, the calendar is updated with the fixed Hijri calendar date. If the date is outside the date range, the system determines the Hijri date using a predetermined conversion algorithm, for example, an astronomical formula, a conversion technique, method of date conversion or the like. The calendar is updated and the user is informed that the date may be slightly inaccurate due to the conversion applied.

Currently, Saudi Arabia uses the Umm al-Qura as a civil calendar as well as a calendar for dating religious events. Some Muslim communities, especially those communities in non-Islamic countries have also started to follow the Umm al-Qura, allowing the Umm al-Qura to become more accepted internationally. The Islamic Society of North America, the Figh Council of North America, and the European Council of Fatwa and Research have all announced that they will follow the Umm al-Qura. The Umm al-Qura uses astronomical calculations that are based on the coordinates of Mecca.

Other Muslim communities, which currently do not follow the Umm al-Qura may develop their own predetermined Hijri calendar according to which the number of days in a month are fixed. Calculations may be based on a similar formula to the Umm al-Qura with modifications as to the coordinates of concern for the particular Muslim community. Further, other Muslim communities may choose to develop their own predetermined Hijri calendars, deriving the calculations from first principles or using an unrelated astronomical formula.

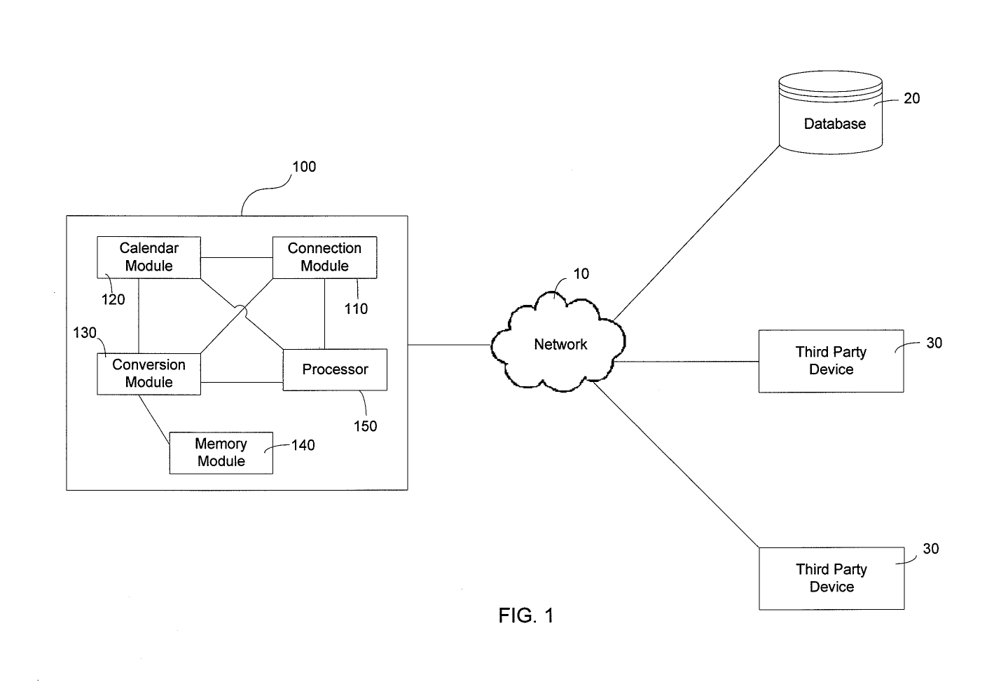

FIG. 1 illustrates a block diagram of a system 100 for a Hijri calendar according to one example embodiment. The system 100 includes a connection module 110, a calendar module 120, a conversion module 130, a memory module 140, and a processor 150.

Referring to FIG. 1, the system 100 is intended to reside on a network enabled device (not shown), for example, a personal computer, a tablet computer, a smartphone, a notebook computer, or the like. The connection module 110 is configured to transmit data to and receive data from a network 10. The network 10 may be, for example, the Internet, a local area network, a virtual network, a wide area network, a wireless network or the like, or a combination of networks. The system 100 via the connection module 110 is able to connect to and query data from, for example, external databases 20, third party devices 30, and the like.

The calendar module 120 is operatively connected to the connection module 110. The calendar module 120 receives input from, for example, a user, an application running on the network enabled device, or the connection module 110 and determines relevant date information associated with the input. The calendar module 120 is further connected to the conversion module 130. The conversion module 130 is configured to receive date information related to a first predetermined calendar from the calendar module 120 and convert the date to a corresponding date on a second predetermined calendar. In this embodiment, the conversion module 130 is configured to convert dates associated with first predetermined calendar, for example Gregorian calendar dates, Hijri calendar dates, Chinese lunar calendar dates, or the like, to dates associated with a second predetermined calendar, for example, a fixed Hijri calendar, such as the Umm al-Qura. If the converted date is outside a date range associated with either predetermined calendar, the conversion module is configured to determine a conversion through a predetermined Hijri conversion algorithm, for example, an astronomical algorithm or formula. Similarly the conversion module 130 may convert Hijri dates to Gregorian dates, Umm al-Qura dates to other fixed or calculated Hijri calendar dates, calculated Hijri dates to fixed Hijri calendar dates, and the like.

The conversion module 130 may also be operatively connected to the memory module 140. The memory module 140 may be the memory for the network enabled device hosting the system 100 or may be a separate memory module for the system 100. In some cases, the memory module 140 may store date related data, for example, conversion and astronomical formulae to be used by the conversion module 130. In other cases, the conversion module 130, via the connection module 110, may query an external database 20 or third party devices 30 for the conversion technique and/or astronomical formulae or method to be used for the date conversion.

In some cases, the memory module 140 may further store details, conversion formulae or date ranges of a predetermined Hijri calendar, for example the Umm al-Qura calendar or other fixed Hijri calendar. The memory module 140 may, on predetermined intervals, for example, once a day, once a month, once a year, query external sources to retrieve any updates or changes to the Umm al-Qura calendar or other fixed Hijri calendar.

The processor 150 is configured to execute the commands of the system modules. The processor 150 may be a central processing unit for the network enabled device hosting the system 100, or may be a plurality of processing units each configured to process commands from at least one of the system modules. Other processing arrangements may be appropriate and would be understood.

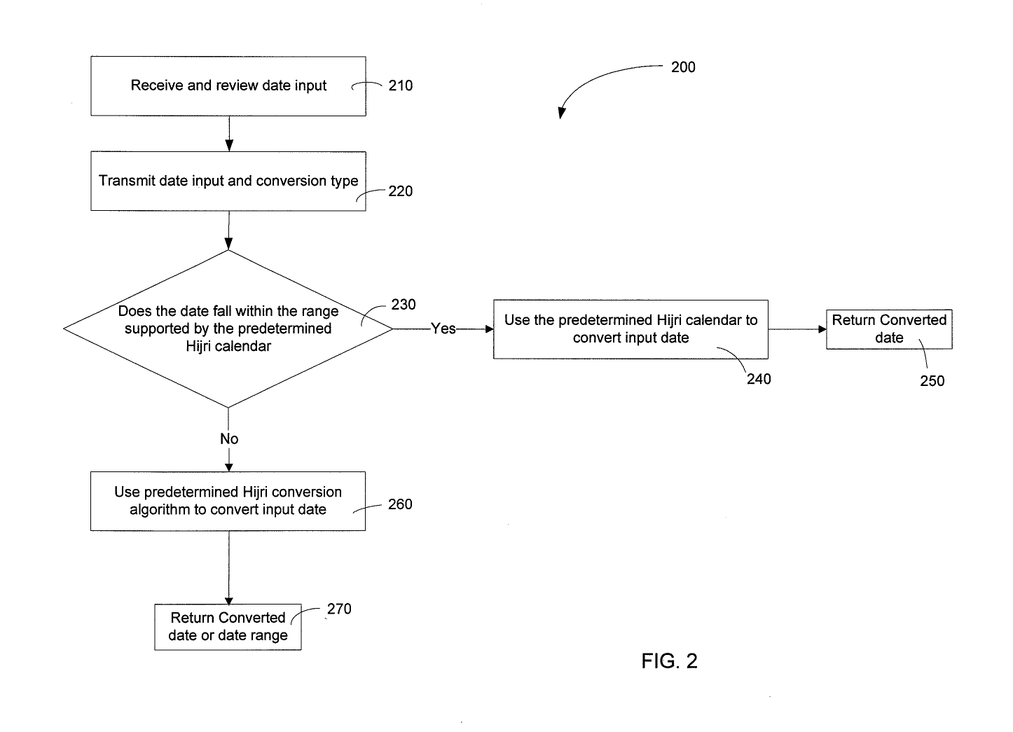

FIG. 2 illustrates a flowchart of a method 200 for a Hijri calendar according to an embodiment.

Referring to FIG. 2, at 210, the system 100 receives a date input related to a first predetermined calendar from an input source, for example a user or from an application being run on the network enabled device hosting the system 100. The calendar module 120 reviews the date input to determine the type of calendar used for the date and the type of conversion requested.

At 220, the calendar module 120 transmits the date input and the type of conversion requested by the input source to the conversion module 130.

At 230, the conversion module 130 determines whether the date falls within the date range supported by the predetermined Hijri calendar being used for the conversion, for example, the Umm al-Qura. The conversion module 130 may determine whether the date falls within the range by querying calendar data stored in the memory module 140 or by querying external sources.

At 240, if the date falls within the range of the predetermined Hijri calendar, the predetermined Hijri calendar will be used to convert the date input. For example, if the predetermined Hijri calendar being used is the Umm al-Qura and the date falls within the range of the Umm al-Qura, the predetermined Hijri calendar will be used to convert the date input.

At 250, the conversion module 130 transmits the converted date to the calendar module 120. The converted date may then be displayed to the user or may be processed by the application requesting the date conversion. It will be understood that if another predetermined or fixed Hijri calendar is selected, then if the date falls within the range of the predetermined Hijri calendar the conversion module 130 will use the selected predetermined Hijri calendar for the date conversion.

At 260, if the date does not fall within the range of the predetermined Hijri calendar, the conversion module 130 uses a predetermined Hijri conversion algorithm to convert the date input. In some cases, the predetermined Hijri conversion algorithm is a known Hijri algorithm using astronomical calculations. In other cases, the predetermined Hijri conversion algorithm may include various conversion methods or techniques which may be used to approximate the corresponding Hijri date based on various astronomical observations and predictions. The conversion module 130 is intended to determine a conversion which will return a converted date as a close approximation as to what the actual date will be or has been. As a generic Hijri calendar relies on the observations of a religious authority, the converted date may be slightly inaccurate.

At 270, the conversion module 130 will return the converted date to the calendar module 120.

In some cases, the calendar module 130 will display the date to the user or return the date to the requesting application with a warning or a caveat that the date may be inaccurate as a Hijri conversion algorithm was used for the conversion. In other cases, the conversion module 130 may return a date range as opposed to a single date taking into account the variance that can be introduced by the Hijri conversion algorithm.

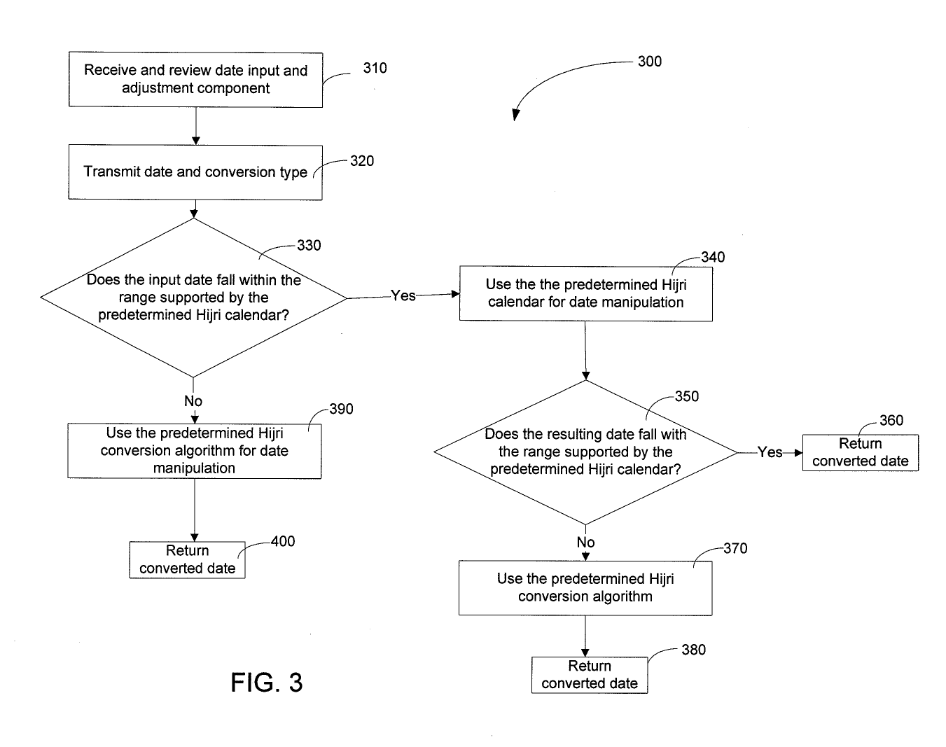

FIG. 3 illustrates a method 300 for date adjustment using an embodiment of the system 100 for a Hijri calendar. Date adjustment may occur, for example, when a user wants to enter a reoccurring appointment for a number of days, months or years; adding a time frame to a pre-existing appointment, for example, a follow-up for a date a number of days, months, or years in the future; or determine an resulting event date by subtracting a number of days, months, or years.

Referring to FIG. 3, at 310, the calendar module 120 receives an originating date from a first predetermined calendar with a date adjustment component from the input source. The date adjustment component includes data detailing how any follow-up or related appointment is to be calculated based on the originating date, for example, the number of reoccurring appointments and the time period between appointments, the length of time for a follow-up related to the originating date, or the like. The calendar module 120 reviews the date input from the first predetermined calendar and determines the type of conversion.

At 320, the calendar module 120 transmits the originating date and the date adjustment component to the conversion module 130.

At 330, the conversion module 130 determines whether the originating date falls within the date range of the predetermined Hijri calendar being used for the conversion, for example, the Umm al-Qura.

At 340, if the conversion module 130 determines that the originating date falls within the range, the conversion module 130 uses the predetermined Hijri calendar for the date adjustment. The conversion module 130 ascertains at least one resulting date after applying the date adjustment component to the originating date. The resulting date may be calculated by adding or subtracting from the originating date as specified in the date adjustment component.

At 350, the conversion module 130 determines whether the resulting date falls within the date range of the predetermined Hijri calendar. If the resulting date does fall within the date range of the predetermined Hijri calendar, the dates calculated are intended to be accurate.

At 360, the resulting dates are transmitted to the input source and may be displayed to the user.

If the resulting date falls outside the date range then the conversion module 130 will disregard the calculated result because if the calculated result is not within the predetermined Hijri calendar date range, then the calculated result is unlikely to be accurate. At 370, the conversion module 130 applies the predetermined Hijri conversion algorithm, an astronomical formula, to determine the resulting date.

In some cases, for a reoccurring date, a similar process will be applied a plurality of times until the conversion module 130 has reached an end date of the reoccurring event.

At 380, the resulting date or resulting dates, if a plurality of calculations were performed, are returned to the input source, for example, the requesting application or displayed to the user. If the predetermined Hijri conversion algorithm was used, a warning or caveat stating that the dates may be inaccurate as the astronomical formula was used may also be returned to the input source. In other cases, each date that was calculated using the astronomical formula may be returned as a date range while dates that were obtained using the predetermined Hijri calendar, a fixed Hijri calendar, may be returned as a fixed converted date.

At 390, if it is determined that the originating date and the resulting dates are outside the date range of the fixed Hijri calendar, the conversion module 130 will use the predetermined Hijri conversion algorithm to convert both the originating date and any resulting date determined from adjusting the originating date with the adjustment component.

At 400, the resulting converted dates are returned to the input source.

In a specific example, the date conversion may be a reoccurring date appointment from a predetermined Hijri calendar to be converted to an appointment in a second predetermined calendar, for example the Gregorian calendar, or Chinese lunar calendar, or the like. The calendar module 120 receives the date input from the predetermined Hijri calendar and a date adjustment component detailing how any follow-up appointment is to be calculated based on the originating date. The conversion module 130 determines that the originating date falls with the range of the predetermined Hijri calendar and converts the originating date to the second predetermined calendar. The conversion module 130 determines at least one resulting date by performing calculations on the originating date as specified in the adjustment component. The conversion module 130 determines whether the resulting date is within the range of the predetermined Hijri calendar. If so, the conversion module 130 will convert the date to the second predetermined calendar using the predetermined Hijri calendar. If the resulting date is outside the date range, the conversion module 130 will convert the date using the predetermined Hijri conversion algorithm.

In some cases, the resulting converted dates may be updated if there is a change or update in the date range supported by a predetermined calendar, for example a fixed Hijri calendar or the Umm al-Qura. In these cases, if date ranges have previously been provided using the predetermined Hijri algorithm or calendar, then a more accurate date can be substituted for the date range. In other cases, where only a date has been provided, the date may be updated to a more correct date if the predetermined Hijri conversion algorithm is found to have provided an inaccurate date or a date that does not correspond to the fixed Hijri calendar date.

In some cases, the predetermined Hijri calendar may only have a limited range of past or future dates. For dates determined to be earlier than the dates within the date range of the predetermined Hijri calendar, the system 100 may query external databases or third party network devices to determine whether further accurate past data has been recorded or stored in any of these sources. In other cases, the user or application may determine that a date range or a date that may a couple days off is adequately accurate and further querying of outside sources is not necessary.

In some cases, the predetermined Hijri calendar used may be dependent on the location of the user. For example, the connection module 110 may include a location component (not shown), for example, a Global Positioning System, which is configured to determine the location of the user of the network enabled device. If the location is determined to be a country or Muslim community with a fixed Hijri calendar, the corresponding calendar may be used in date conversion as the predetermined Hijri calendar. In other cases, the user's location may be predetermined, for example, entered by the user, and stored in the memory module 140. In still other cases, the user may select which location or which fixed Hijri calendar to use and the user's selection may be stored in the memory module 140 and retrieved by the conversion module 130.

In some cases, the predetermined Hijri calendar may be based on astronomical calculations which include geographical coordinates of the local Muslim community. For example, the Umm al-Qura algorithm includes calculations based on the coordinates of the Great Mosque of Mecca. The system 100, using the location data, may be able to determine a fixed Hijri calendar date based on the current geographical location of the user. By determining the geographic location of the user, the system 100 may be able to calculate the resulting Hijri calendar date by using the same or similar algorithm as the Umm al-Qura but with the substitution of the user's current geographical location.

In a specific case, the user's calendar dates may be updated when the system 100 detects that the user has changed location. For example, the user may be located in a Muslim community that has embraced the use of the Umm al-Qura and the system 100 may have calculated date conversions accordingly. If the system 100 determines that the user has changed location to a location with a different predetermined Hijri calendar, the system 100 may update the converted dates. In some cases, the system 100 may prompt the user prior to updating the converted dates to determine if the user prefers to continue using the current predetermined Hijri calendar or if the user would like to update the converted dates.

In some cases, if the date conversion is a date in the past, the conversion module 130 may query third party systems or databases to see if there is an accurate record of the historical date. As accurate record keeping was less customary in the past, it may be that key religious dates or dates which have an importance in history may have been recorded. If the conversion module determines that the input date is an accurately recorded date in history or is proximate to an accurately record date, the conversion module 130 may determine the past date more precisely. The conversion module 130 may determine the date in history and further may determine how accurate the converted date is based on other dates in proximity to the converted date.

In a specific case, the system 100 may receive not only a date input from a user or requesting application but may further receive a location as to where the event is to occur, or, if the date was in the past, where the event occurred. The system 100 may convert the date based on the predetermined Hijri calendar used in the specified location of the event and may return a converted date that is location specific. In other cases, the system 100 may return two dates to the user if the location uses a separate fixed calendar or if there are past records of the date at the location that differs from the date conversion of the user's location. In still other cases, the system 100 may prompt the user to specify the location for the conversion, either the user's current location or the location of the event related to the date input.

Dates outside the date range of the predetermined or fixed Hijri calendar may be generally considered as inaccurate as the actual date change of the month may vary depending on when a religious authority is able to observe the moon. As such, dates calculated by the predetermined Hijri algorithm may be a couple of days off the actual date, as months do not have a fixed number of days and can vary between 29 and 30 days. In some cases, to deal with this potential inaccuracy, the system 100 may return a date range to include the possible dates that could be the accurate date of the converted date. In other cases, the system 100 may return a single date and may include a warning with respect to the date potentially being an inaccurate conversion.

In some cases, the system 100 may query third party systems and/or databases in predetermined intervals, for example, once a week, once a month, once a year, or the like, to determine if any of the possibly inaccurate dates now fall within a date range of, for example, the predetermined Hijri calendar and the converted date can be updated to an accurate date.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a non-transitory machine-readable medium (also referred to as a non-transitory computer-readable medium, a non-transitory processor-readable medium, or a non-transitory computer usable medium having a computer-readable program code embodied therein). The non-transitory machine-readable medium can be any suitable tangible, non-transitory medium, including magnetic, optical, or electrical storage medium including a diskette, Compact Disk Read Only Memory (CD-ROM), memory device (volatile or non-volatile), or similar storage mechanism. The non-transitory machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the non-transitory machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A method for managing a Hijri calendar comprising:
receiving date input from a first predetermined calendar for a date conversion;
determining a conversion type associated with the date input;
determining whether the date input falls within a predetermined Hijri calendar date range;
if the date input falls within the date range, using the predetermined Hijri calendar to convert the date input, otherwise, using a predetermined Hijri conversion algorithm to convert the date input;
returning a converted date output.

2. The method of claim 1 wherein the receiving of the date input comprises receiving an originating date and a date adjustment component.

3. The method of claim 2 wherein the determining as to whether the date input falls within a predetermined Hijri calendar date range comprises:
determining at least one resulting date by applying the date adjustment component to the originating date;
determining whether the at least one resulting date falls within the date range of the predetermined Hijri calendar; and
if the at least one resulting date falls within the date range, using the predetermined Hijri calendar to convert the at least one resulting date, otherwise, using the predetermined Hijri conversion algorithm to convert the at least one resulting date.

4. The method of claim 1 wherein, if the date is converted using the predetermined Hijri conversion algorithm, the converted date output is a date range of possible conversion dates.

5. The method of claim 1 wherein, if the date is converted using the predetermined Hijri conversion algorithm, the converted date output is a date and a warning that the date may be inaccurate.

6. The method of claim 1, wherein the predetermined Hijri calendar used to convert the date input is based upon a user's location.

7. The method of claim 1, wherein the predetermined Hijri calendar used to convert the date input is selected by a user.

8. The method of claim 1 further comprising:
determining if the date range of the predetermined Hijri calendar has been updated; and
if the date range has been updated, updating the conversion of any converted dates falling within the updated date range of the predetermined Hijri calendar.

9. The method of claim 1, wherein if the date input falls outside of the predetermined Hijri calendar, querying at least one third party system or database to retrieve a more accurate converted date for the date input.

10. The method of claim 6 further comprising:
receiving a change in the user's location to a new location;
determining whether a different predetermined Hijri calendar is used at the new location; and
if a different predetermined Hijri calendar is used at the new location, updating any converted dates using the different predetermined Hijri calendar used in the new location.

11. A system for a Hijri calendar comprising:
a calendar module configured to receive date input for a date conversion and to determine a conversion type associated with the date input; and
a conversion module configured to determine whether the date input falls within a predetermined Hijri calendar date range and further configured to, if the date input falls within the date range, use the predetermined Hijri calendar to convert the date input, otherwise, use a predetermined Hijri conversion algorithm to convert the date input, and return a converted date output.

12. The system of claim 11 wherein the calendar module is further configured to receive an originating date and a date adjustment component.

13. The system of claim 12 wherein the conversion module, when determining whether the date input falls within a predetermined Hijri calendar date range, is further configured to:
determine at least one resulting date by applying the date adjustment component to the originating date;
determine whether the at least one resulting date falls within the date range of the predetermined Hijri calendar; and
if the at least one resulting date falls within the date range, using the predetermined Hijri calendar to convert the at least one resulting date, otherwise, using the predetermined Hijri conversion algorithm to convert the at least one resulting date.

14. The system of claim 11 wherein, if the date is converted using the predetermined Hijri conversion algorithm, the calendar module is configured to return the converted date output as a date range of possible conversion dates.

15. The system of claim 11 wherein, if the date is converted using the predetermined Hijri conversion algorithm, the calendar module is configured to return the converted date output as a date and a warning that the date may be inaccurate.

16. The system of claim 11, wherein the predetermined Hijri calendar used to convert the date input is based upon a user's location.

17. The system of claim 1 wherein the conversion module is further configured to:
determine if the date range of the predetermined Hijri calendar has been updated; and
if the date range has been updated, the conversion module is further configured to update the conversion of any converted dates falling within the updated date range of the predetermined Hijri calendar.

18. The system of claim 11, further comprising a connection module configured to query at least one third party system or database to retrieve a more accurate converted date for the date input, the date input falls outside of the predetermined Hijri calendar.

19. The system of claim 16 wherein the conversion module is further configured to:
receive a change in the user's location to a new location;
determine whether a different predetermined Hijri calendar is used at the new location; and
if a different predetermined Hijri calendar is sued at the new location, updating any converted dates using the different predetermined Hijri calendar used in the new location.

20. A non-transitory computer readable medium containing instructions, that, when executed, perform the method of claim 1.
